(19) United States
(12) Patent Application Publication
(10) Pub. No.: US 2018/0059355 A1
(43) Pub. Date: Mar. 1, 2018

(54) Securing Filters to Camera Lenses

(71) Applicant: Wooden Camera, Inc., Dallas, TX (US)

(72) Inventor: Ryan Reed Schorman, Dallas, TX (US)

(21) Appl. No.: 15/249,307

(22) Filed: Aug. 26, 2016

(51) Int. Cl. G02B 7/00; G03B 11/00

(52) U.S. Cl. CPC G02B 7/006; G03B 11/00

(57) ABSTRACT

A method of securing a filter to a lens includes urging a filter into a flexible sleeve of a filter holder such that the flexible sleeve stretches to accommodate the filter and grasps the filter and securing a flexible mount of the filter holder to the lens such that the filter, held within the flexible sleeve, is positioned in front of the lens. The flexible sleeve and the flexible mount are defined by a support structure that includes a stretchable material.

### TECHNICAL FIELD

This disclosure relates to securing optical filters in front of lenses.

### BACKGROUND

Various types of filter supports (e.g., matte boxes or threaded filters) may be used to position filters in front of cameras lenses during photographing and filming. Such filter supports typically include multiple components that are made of metal or plastic. The filter supports are designed to be attached to a lens body of a particular diameter using rigid clamps that are sized to engage the particular lens body. The filter supports also include multiple components (e.g., tabs, springs, and threads) that can be manipulated to support a filter in front of the camera lens. Owing to the multi-part construction of the filter supports, manipulating the filter supports for use with a filter and a camera lens can be a tedious, time-consuming process. The metal or plastic material formulation of the multi-part construction also results in significant product weight and costs associated with producing the filter supports.

### SUMMARY

Implementations of the present disclosure provide filter holders with an improved construction and an improved material formulation that enable a filter to be easily and quickly secured in front of a camera lens during filming, photographing, or image acquisition for industrial applications.

In one aspect, a method of securing a filter to a lens includes urging a filter into a flexible sleeve of a filter holder such that the flexible sleeve stretches to accommodate the filter and grasps the filter and securing a flexible mount of the filter holder to the lens such that the filter, held within the flexible sleeve, is positioned in front of the lens. The flexible sleeve and the flexible mount are defined by a support structure that includes a stretchable material.

In some embodiments, the support structure is formed as a single component that is made of a rubber material.

In certain embodiments, the method further includes shielding the filter with a hood that is defined by the support structure and that surrounds the flexible sleeve.

In some embodiments, securing the flexible mount of the filter holder to the lens includes releasably attaching the flexible mount to the lens using an adjustable clamp.

In certain embodiments, the method further includes placing the flexible mount of the filter holder around the lens.

In some embodiments, the method further includes urging the flexible mount of the filter holder onto the lens such that the flexible mount stretches to accommodate the lens.

In certain embodiments, securing the flexible mount of the filter holder to the lens includes tightening an adjustable clamp of the filter holder around the flexible mount and the lens.

In some embodiments, securing the flexible mount of the filter holder to the lens includes positioning the filter at a distance of about 1.4 mm to about 1.6 mm from a front end of the lens.

In certain embodiments, the lens has an outer diameter within an inclusive range of 80 mm-85 mm, 90 mm-95 mm, or 110 mm-115 mm.

In some embodiments, the filter has a width of 100 mm and a length of 100 mm or 142.2 mm.

In another aspect, a filter holder for securing a filter to a lens includes a flexible filter sleeve configured to stretch to accommodate the filter and to grasp the filter and a flexible lens mount configured to be secured to the lens to position the filter in front of the lens with the filter held within the flexible filter sleeve. The flexible filter sleeve and the flexible lens mount are defined by a support structure that includes a stretchable material.

In some embodiments, the support structure is formed as a single component that is made of a rubber material.

In certain embodiments, the support structure further defines a hood that surrounds the flexible sleeve.

In some embodiments, the filter holder further includes an adjustable clamp by which the flexible filter mount can be releasably secured to the lens.

In certain embodiments, the flexible lens mount is formed as a ring that can be placed around the lens.

In some embodiments, the flexible lens mount is formed as a ring that can be urged onto the lens such that the ring stretches to accommodate the lens.

In certain embodiments, the flexible filter sleeve includes a wall including a first side that is configured to support the filter and a second side that is configured to contact a front end of the lens, the wall having a thickness of about 1.4 mm to about 1.6 mm.

In some embodiments, the lens has an outer diameter within an inclusive range of 80 mm-85 mm, 90 mm-95 mm, or 110 mm-115 mm.

In certain embodiments, the filter has a width of 100 mm and a length of 100 mm or 142.2 mm.

In another aspect, a filter holder for securing a filter to a lens includes a flexible filter grasping means that is configured to stretch to accommodate the filter and to grasp the filter and a flexible lens mounting means that is configured to be secured to the lens to position the filter in front of the lens when the filter is held within the flexible filter grasping means. The flexible filter grasping means and the flexible lens mounting means are defined by a supportive structural means that includes a stretchable material.

Implementations of the present disclosure may provide one or more of the following potential advantages.

In some embodiments, the support structure of the filter holder may be made of one or more rubber materials with a modulus of elasticity that allows the support structure to stretch and to relax so that the filter can be placed (e.g., urged) within a seat of the support structure and so that the mount can be attached to (e.g., stretched to surround) camera lenses with lens bodies that have a range of diameters. The flexible construction of the support structure enables the support structure of the filter holder to hold the filter more securely (e.g., to grip the filter more tightly) than can conventional filter holders made of plastic or metal with a relatively rigid structure. Furthermore, the unitary form of the support structure enables a simpler filter installation, as compared to conventional filter holders including multiple components that must be manipulated to secure a filter. Such a unitary rubber construction also enables the filter holder to be manufactured at a significantly lower cost as compared to conventional filter holders made of multiple metal or plastic components. Together with the material formulation of the support structure, the adjustability of the clamp allows the filter holder to advantageously be fitted with multiple camera lenses with lens bodies that have a range of diameters, as opposed to conventional filter holders made of metal or plastic that are designed to be attached to only a single camera lens using a fixed-diameter clamp.

In certain embodiments, a relatively small thickness of the wall between a flat surface against which the filter is seated and a rear side against which the lens body of the camera lens is abutted locates the filter axially much closer to a front end of the camera lens than do conventional filter holders made of metal or plastic, which, due to thicknesses of multiple components involved in securing a filter, may locate the filter axially farther away from the front end of the camera lens. Locating the filter relatively close to the end of the camera lens advantageously reduces an amount of vignetting that may otherwise occur if the filter were to be located axially farther from the camera lens.

One of skill in the art will appreciate that the disclosure is not limited to the embodiments described above and is intended to cover embodiments described in this specification, as well as other embodiments that are within the spirit and scope of the specification, the drawings, and the claims set forth below.

### DESCRIPTION OF DRAWINGS

FIG. 1 is a perspective view of a filter holder securing a filter to a camera lens.

FIG. 2 is a front view of the filter holder of FIG. 1.

FIG. 3 is a rear perspective view of the filter holder of FIG. 1.

FIG. 4 is a cross-sectional view of the filter holder of FIG. 1.

FIGS. 5-8 illustrate a method of securing the filter of FIG. 1 within the filter holder of FIG. 1.

FIG. 9 is a flow chart of an example process for securing a filter to a lens.

FIG. 10 is a front view of a filter holder.

FIG. 11 is a rear perspective view of the filter holder of FIG. 10.

FIG. 12 is a front view of a filter holder.

FIG. 13 is a rear perspective view of the filter holder of FIG. 12.

FIG. 14 is a front view of a filter holder.

FIG. 15 is a rear perspective view of the filter holder of FIG. 14.

FIG. 16 is a front view of a filter holder.

FIG. 17 is a rear perspective view of the filter holder of FIG. 16.

Like reference numbers and designations in the various drawings indicate like elements.

### DETAILED DESCRIPTION

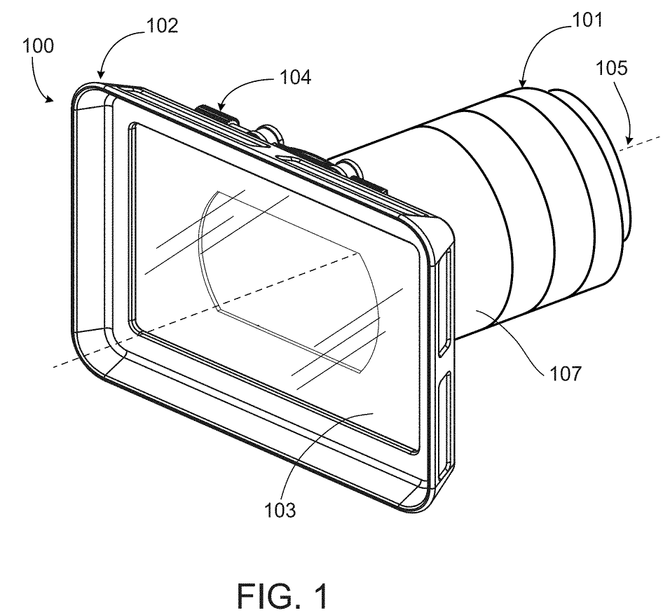

FIG. 1 displays a perspective view of a filter holder 100 mounted to a camera lens 101 that may be used for still photography, filming (e.g., cinematography), or industrial applications. The camera lens 101 includes a lens body 107 that houses one or more optical elements through which light passes for generating an image. The filter holder 100 secures a filter 103 in front of the camera lens 101 in a position that is centrally aligned with the camera lens 101 (e.g., along a central axis 105 of the camera lens 101). The filter holder 100 may be easily and quickly assembled with a particular filter (e.g., the filter 103) and a camera lens within a range of sizes. The filter holder 100 includes a support structure 102 that holds (e.g., grasps) the filter 103 and a clamp 104 that secures the support structure 102 to the camera lens 101.

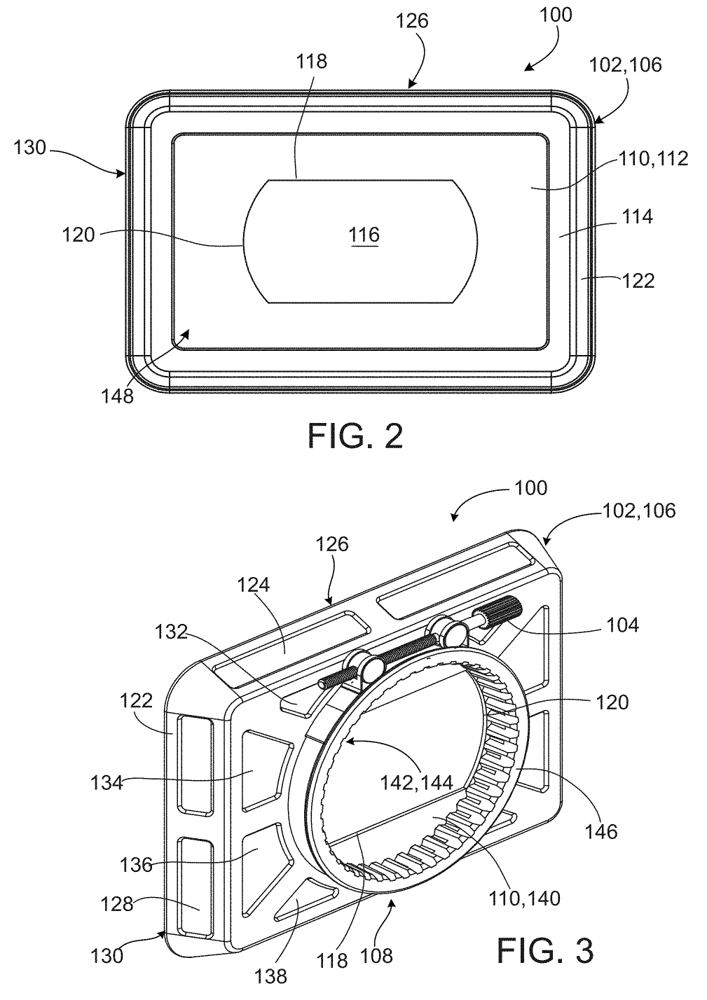

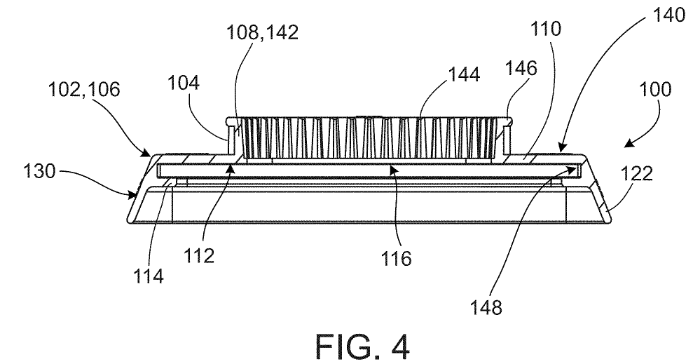

FIGS. 2-4 display front, rear perspective, and cross-sectional views, respectively, of the filter holder 100. The support structure 102 is formed as a single flexible, rubber component that can stretch and relax to accommodate camera lenses and filters of various sizes. The support structure 102 includes a seat 106 that supports the filter 103 and a mount 108 by which the filter holder 100 can be secured to the camera lens 101. The seat 106 includes a wall 110 with a flat surface 112 against which the filter 103 is held and a lip 114 that secures the filter 103 against the flat surface 112 of the wall 110. The lip 114 overlaps a peripheral edge of the wall 110 to secure (e.g., to compress) the filter 103 against the flat surface 112 of the wall 110. In this manner, the wall 110 and the lip 114 together form a sleeve 148 in which the filter 103 is grasped.

The seat 106 also defines an opening 116 through which the camera lens 101 can capture light rays to produce an image. The opening 116 has two straight edges 118 defining a width therebetween that defines a rectangular area associated the diameter of the camera lens 101. The opening 116 also has two curved edges 120 positioned along the mount 108 and defining a length therebetween that spans an outer diameter of the lens body 107.

The seat 106 of the support structure 102 also includes a hood 122 that extends along the peripheral edge of the wall 110. The hood 122 shields the filter 103 and the camera lens 101 by blocking stray light rays from impinging upon the filter 103 and the camera lens 101. The hood 122 defines two recesses 124 disposed along first opposing sides 126 and two recesses 128 disposed along second opposing sides 130. The wall 110 of the seat 106 also includes multiple recesses 132, 134, 136, 138 positioned along a rear side 140. The recesses 124, 128, 132, 134, 136, 138 serve to reduce a weight of the support structure 102 and to decrease a stiffness of the support structure 102 resulting from reduced material.

The mount 108 of the support structure 102 includes a cylindrical wall 142 (e.g., a ring) that extends from the rear side 140 of the seat 106 and a series of triangular-shaped projections 144 (e.g., ridges) that extend radially inward from the cylindrical wall 142. The projections 144 provide additional friction that improves a grip of the cylindrical wall 142 on the lens body 107 of the camera lens 101. The mount 108 also has an annular flange 146 that extends perpendicularly from the cylindrical wall 142. The annular flange 146 helps to secure the clamp 104 (e.g., an adjustable hose clamp) on the support structure 102 by limiting axial movement of the clamp 104 along the cylindrical wall 142 of the mount 108. The mount 108 is sized and sufficiently flexible to be mounted to camera lenses that have a range of diameters.

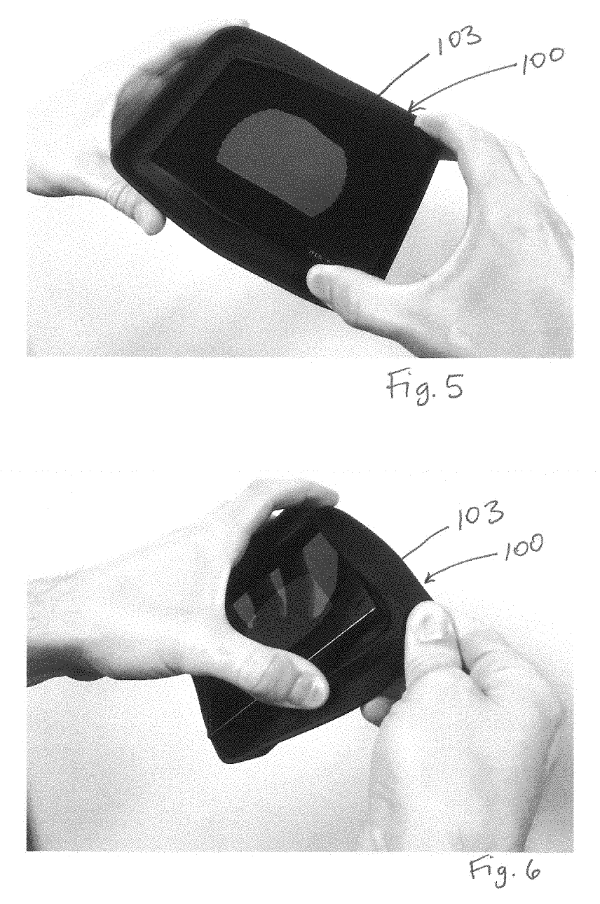

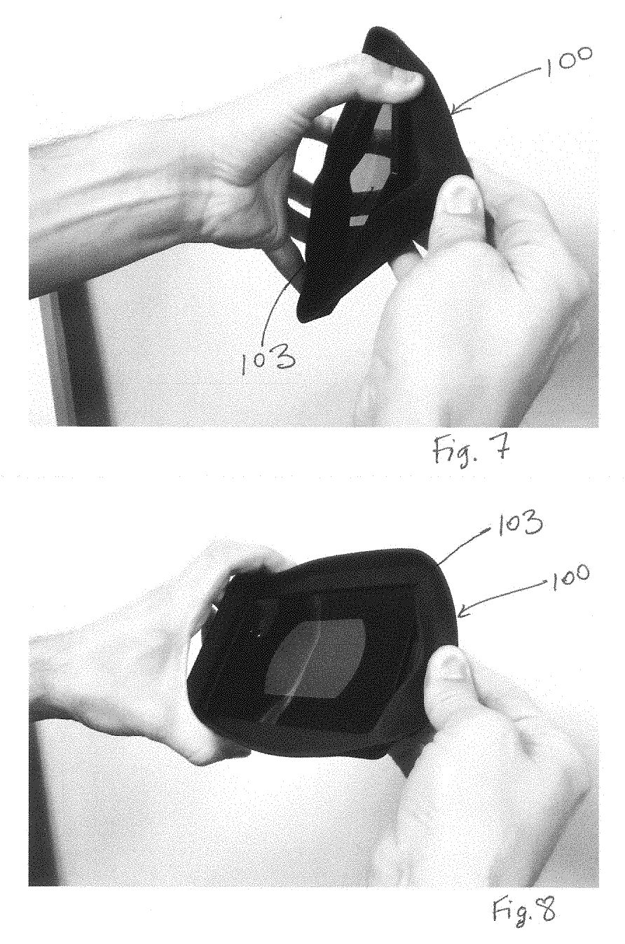

FIGS. 5-8 illustrate a method of securing the filter 103 within the filter holder 100. To secure the filter 103 within the seat 106 of the support structure 102, an edge of the filter 103 can be urged between the wall 110 and the lip 114 along one side of the seat 106, thereby causing the seat 106 to stretch to accommodate the edge of the filter 103, as shown in FIG. 5. Referring to FIG. 6, once the edge of the filter 103 is positioned between the wall 110 and the lip 114 against the one side of the seat 106, the remaining edges of the filter 103 can be urged between the wall 110 and the lip 114 along respective remaining sides of the seat 106. Accordingly, the seat 106 is further stretched to accommodate the filter 103, as shown in FIG. 7. In this manner, the support structure 102 of the filter holder 100 grasps the filter 103 within the sleeve 148 of the seat 106, as shown in FIG. 8.

With the filter 103 fitted within the seat 106 of the support structure 102, the mount 108 of the support structure 102 can be slid over the lens body 107 of the camera lens 101 until the lens body 107 abuts the rear side 140 of the seat 106. In cases where a radial clearance exists between the lens body 107 and a nominal internal diameter defined by the multiple projections 144, the mount 108 can be moved freely over the camera lens 101. In cases where an outer diameter of the lens body 107 is greater than the nominal internal diameter defined by the multiple projections 144, the mount 108 can be urged over the camera lens 101 in a manner that radially compresses the multiple projections 144 and that radially expands (e.g., stretches) the cylindrical wall 142 of the mount 108 to accommodate the camera lens 101. Once the camera lens 101 has been placed within the mount 108 against the rear side 140 of the seat 106, the clamp 104 can be tightened to secure the mount 108 onto the camera lens 101.

The clamp 104 can subsequently be loosened so that the camera lens 101 can be removed (e.g., pulled) from the support structure 102 of the filter holder 100. To remove the filter 103 from the seat 106 of the support structure 102, the seat 106 can be stretched along one side of the sleeve 148 to expose the respective side of the filter 103. The filter 103 can then be grasped along the exposed side and pulled from the sleeve 148 of the seat 106.

The support structure 102 of the filter holder 100 may be made of one or more rubber materials with a relatively low modulus of elasticity that allows the support structure 102 to stretch and to relax so that the filter 103 can be placed (e.g., urged) within the seat 106 and so that the mount 108 can be attached to (e.g., stretched to surround) camera lenses (e.g., including the camera lens 101) that have a range of diameters. Example rubber materials from which the support structure 102 may be made include silicon (e.g., silicon 50A) or other rubber materials. The flexible construction of the support structure 102 enables the support structure 102 of the filter holder 100 to hold the filter 103 more securely (e.g., to grip the filter 103 more tightly) than can conventional filter holders made of plastic or metal with a relatively rigid structure. Furthermore, the unitary form of the support structure 102 enables a simpler filter installation, as compared to conventional filter holders including multiple components (e.g., tabs, springs, knobs, clamps, and threads) that must be manipulated to secure a filter. Such a unitary rubber construction also enables the filter holder 100 to be manufactured as a light-weight component at a significantly lower cost as compared to conventional filter holders made of multiple metal or plastic components. The support structure 102 may be manufactured via one or more processes including injection molding and casting of liquid rubber.

Example materials from which the clamp 104 may be made include metals, plastics, and rubber materials. Together with the material formulation of the support structure 102, the adjustability of the clamp 104 allows the filter holder 100 to advantageously be fitted with multiple camera lenses that have a range of diameters, as opposed to conventional filter holders made of metal or plastic that are designed to be attached to only a single camera lens using a fixed-diameter clamp.

The support structure 102 of the filter holder 100 is sized to accommodate a filter (e.g., a rectangular filter, such as the filter 103) that has a length of 142.2 mm, a width of 100 mm, and a thickness of 4 mm. Accordingly, the sleeve 148 defined by the seat 106 of the support structure 102 typically has a nominal length of about 141.7 mm to about 142.7 mm (e.g., 142.2 mm), a nominal width of about 99.5 mm to about 100.5 mm (e.g., 100.0 mm), and a nominal thickness of about 3.8 mm to about 4.2 mm (e.g., 4.0 mm). The support structure 102 of the filter holder 100 is sized to accommodate camera lenses with lens bodies that have outer diameters ranging from 80 mm to 85 mm. Thus, the multiple projections 144 lining the cylindrical wall 142 of the mount 108 typically define a nominal internal diameter of about 80.5 mm to about 81.5 mm (e.g., 81.0 mm). The hood 122 typically provides a coverage distance (e.g., as measured axially from a rear side of the lip 114 to an outer-most edge of the hood 122) of about 12.3 mm to about 13.3 mm (e.g., 12.8 mm).

The support structure 102 typically has a total thickness (e.g., a depth) of about 29.3 mm to about 30.3 mm (e.g., 29.8 mm). A thickness of the wall 110 between the flat surface 112 against which the filter 103 is seated and the rear side 140 against which the lens body 107 of the camera lens 101 is abutted through the mount 108 is typically about 1.4 mm to about 1.6 mm (e.g., 1.5 mm). Such a relatively thin wall thickness locates the filter 103 axially much closer to an end of the camera lens 101 than do conventional filter holders made of metal or plastic, which, due to thicknesses of multiple components involved in securing a filter, may locate the filter about 5 mm to about 15 mm axially from an end of a camera lens. Locating the filter 103 relatively close to the end of the camera lens 101 advantageously reduces an amount of vignetting that may otherwise occur if the filter 103 were to be located axially farther from the camera lens 101.

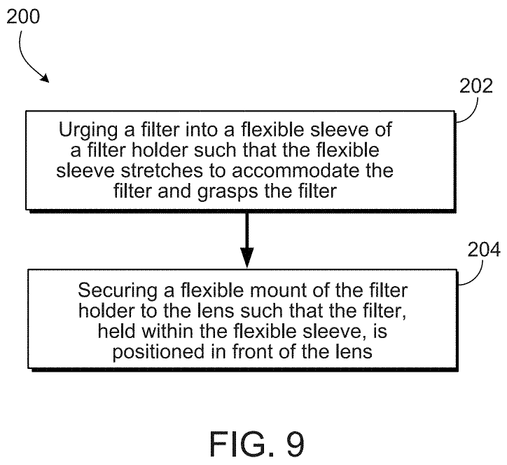

FIG. 9 displays a flow chart of an example process 200 for securing a filter (e.g., the filter 103) to a camera lens (e.g., to the lens body 107 of the camera lens 101). A filter can be urged into a flexible sleeve (e.g., the sleeve 148) of a filter holder (e.g., the filter holder 100) such that the flexible sleeve stretches to accommodate the filter and grasps the filter (202). A flexible mount (e.g., the mount 108) of the filter holder can be secured to the lens such that the filter, held within the flexible sleeve, is positioned in front of the lens (204). In some embodiments, the flexible sleeve and the flexible mount are defined by a support structure that includes a stretchable material. For example, the support structure may be formed as a single component that is made of a rubber material.

In some embodiments, securing the flexible mount of the filter holder to the lens includes releasably attaching the flexible mount to the lens using an adjustable clamp (e.g., the clamp 104). In some embodiments, the process further includes placing the flexible mount of the filter holder around the lens. In some embodiments, the process further includes urging the flexible mount of the filter holder onto the lens such that the flexible mount stretches to accommodate the lens. In some embodiments, securing the flexible mount of the filter holder to the lens includes tightening an adjustable clamp of the filter holder around the flexible mount and the lens. In some embodiments, securing the flexible mount of the filter holder to the lens includes positioning the filter at a distance of about 1.3 mm to about 1.7 mm from a front end of the lens.

In some embodiments, the method further includes shielding the filter with a hood that is defined by the support structure and that surrounds the flexible sleeve. In some embodiments, the lens has an outer diameter within an inclusive range of 80 mm-85 mm, 90 mm-95 mm, or 110 mm-115 mm. In some embodiments, the filter has a width of 100 mm and a length of 100 mm or 142.2 mm.

While the filter holder 100 has been described as being sized for use with a filter of a given size and for use with camera lenses that have diameters within a given range, other embodiments are possible. For example, FIGS. 6-13 illustrate filter holders 300, 400, 500, 600 that are substantially similar in structure, material formulation, and function to the filter holder 100, except that the filter holders 300, 400, 500, 600 are sized for use with filters of different sizes and/or for use with camera lenses that have a different range of diameters. Accordingly, the filter holders 300, 400, 500, 600 may be assembled with a filter and a camera lens in the manner as described above with respect to the filter holder 100. Each of the filter holders 300, 400, 500, 600 includes the adjustable clamp 104 and a respective support structure 302, 402, 502, 602. The support structures 302, 402, 502, 602 of the filter holders 300, 400, 500, 600 may define a different number of recesses or recesses of different shapes as compared to the support structure 102 of the filter holder 100.

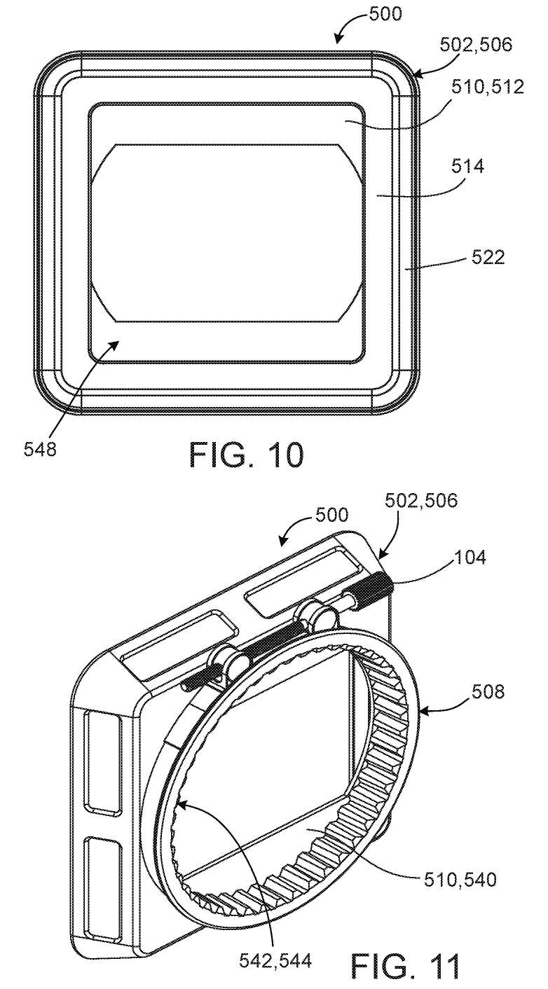

Referring to FIGS. 10 and 11, the support structure 302 of the filter holder 300 is sized to accommodate a filter (e.g., a square filter) that has a length of 100 mm, a width of 100 mm, and a thickness of 4 mm. Accordingly, a sleeve 348 defined by a seat 306 of the support structure 302 typically has a nominal length of about 99.5 mm to about 100.5 mm (e.g., 100.0 mm), a nominal width of about 99.5 mm to about 100.5 mm (e.g., 100.0 mm), and a nominal thickness of about 3.8 mm to about 4.2 mm (e.g., 4.0 mm). The support structure 302 of the filter holder 300 is sized to accommodate camera lenses with lens bodies that have outer diameters ranging from 80 mm to 85 mm. Thus, multiple projections 344 lining a cylindrical wall 342 of a mount 308 of the support structure 302 typically define a nominal internal diameter of about 81.5 mm to about 82.5 mm (e.g., 82.0 mm). A hood 322 of the seat 306 typically provides a coverage distance (e.g., as measured axially from a rear side of a lip 314 of the seat 306 to an outer-most edge of the hood 322) of about 12.3 mm to about 13.3 mm (e.g., 12.8 mm). The support structure 302 typically has a total thickness (e.g., a depth) of about 29.3 mm to about 30.3 mm (e.g., 29.8 mm). A thickness of a wall 310 of the seat 306 between a flat surface 312 against which the filter is seated and a rear side 340 against which a lens body of a camera lens is abutted through the mount 308 is typically about 1.4 mm to about 1.6 mm (e.g., 1.5 mm).

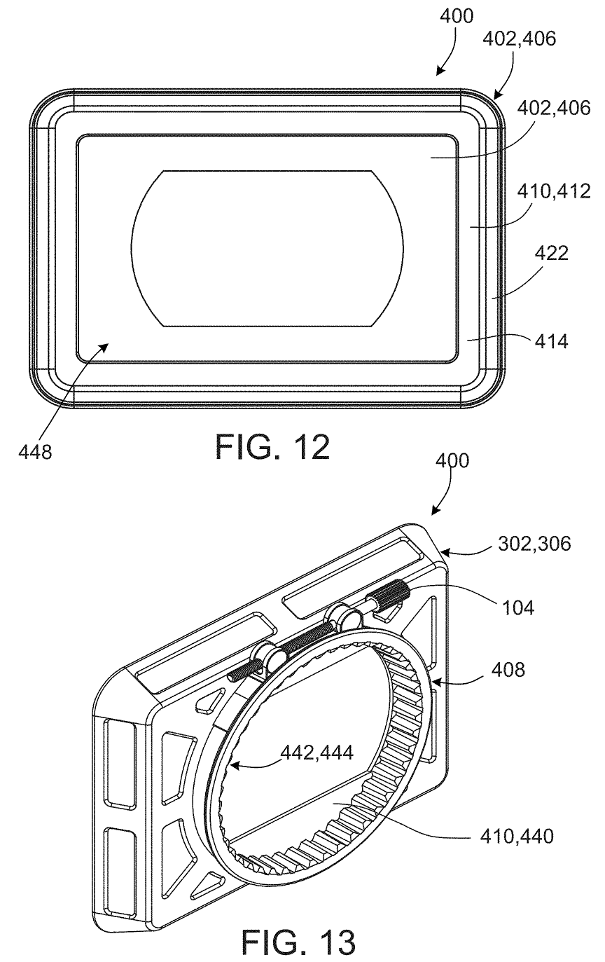

Referring to FIGS. 12 and 13, the support structure 402 of the filter holder 400 is sized to accommodate a filter (e.g., a rectangular filter) that has a length of 142.2 mm, a width of 100 mm, and a thickness of 4 mm. Accordingly, a sleeve 448 defined by a seat 406 of the support structure 402 typically has a nominal length of about 141.7 mm to about 142.7 mm (e.g., 142.2 mm), a nominal width of about 99.5 mm to about 100.5 mm (e.g., 100.0 mm), and a nominal thickness of about 3.8 mm to about 4.2 mm (e.g., 4.0 mm). The support structure 402 of the filter holder 400 is sized to accommodate camera lenses with lens bodies that have outer diameters ranging from 90 mm to 95 mm. Thus, multiple projections 444 lining a cylindrical wall 442 of a mount 408 of the support structure 402 typically define a nominal internal diameter of about 93.0 mm to about 95.0 mm (e.g., 94.0 mm). A hood 422 of the seat 406 typically provides a coverage distance (e.g., as measured axially from a rear side of a lip 414 of the seat 406 to an outer-most edge of the hood 422) of about 12.3 mm to about 13.3 mm (e.g., 12.8 mm). The support structure 402 typically has a total thickness (e.g., a depth) of about 29.3 mm to about 30.3 mm (e.g., 29.8 mm). A thickness of a wall 410 of the seat 406 between a flat surface 412 against which the filter is seated and a rear side 440 against which a lens body of a camera lens is abutted through the mount 408 is typically about 1.4 mm to about 1.6 mm (e.g., 1.5 mm).

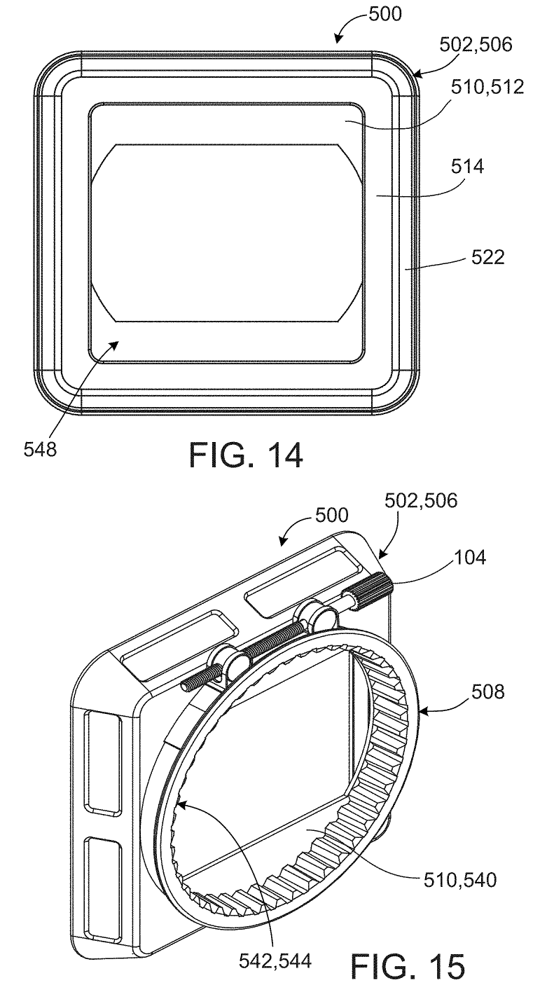

Referring to FIGS. 14 and 15, the support structure 502 of the filter holder 500 is sized to accommodate a filter (e.g., a square filter) that has a length of 100 mm, a width of 100 mm, and a thickness of 4 mm. Accordingly, a sleeve 548 defined by a seat 506 of the support structure 502 typically has a nominal length of about 99.5 mm to about 100.5 mm (e.g., 100.0 mm), about 99.5 mm to about 100.5 mm (e.g., 100.0 mm), and a nominal thickness of about 3.8 mm to about 4.2 mm (e.g., 4.0 mm). The support structure 502 of the filter holder 500 is sized to accommodate camera lenses with lens bodies that have outer diameters ranging from 90 mm to 95 mm. Thus, multiple projections 544 lining a cylindrical wall 542 of a mount 508 of the support structure 502 typically define a nominal internal diameter of about 93.0 mm to about 95.0 mm (e.g., 94.0 mm). A hood 522 of the seat 506 typically provides a coverage distance (e.g., as measured axially from a rear side of a lip 514 of the seat 506 to an outer-most edge of the hood 522) of about 12.3 mm to about 13.3 mm (e.g., 12.8 mm). The support structure 502 typically has a total thickness (e.g., a depth) of about 29.3 mm to about 30.3 mm (e.g., 29.8 mm). A thickness of a wall 510 of the seat 506 between a flat surface 512 against which the filter is seated and a rear side 540 against which a lens body of a camera lens is abutted through the mount 508 is typically about 1.4 mm to about 1.6 mm (e.g., 1.5 mm).

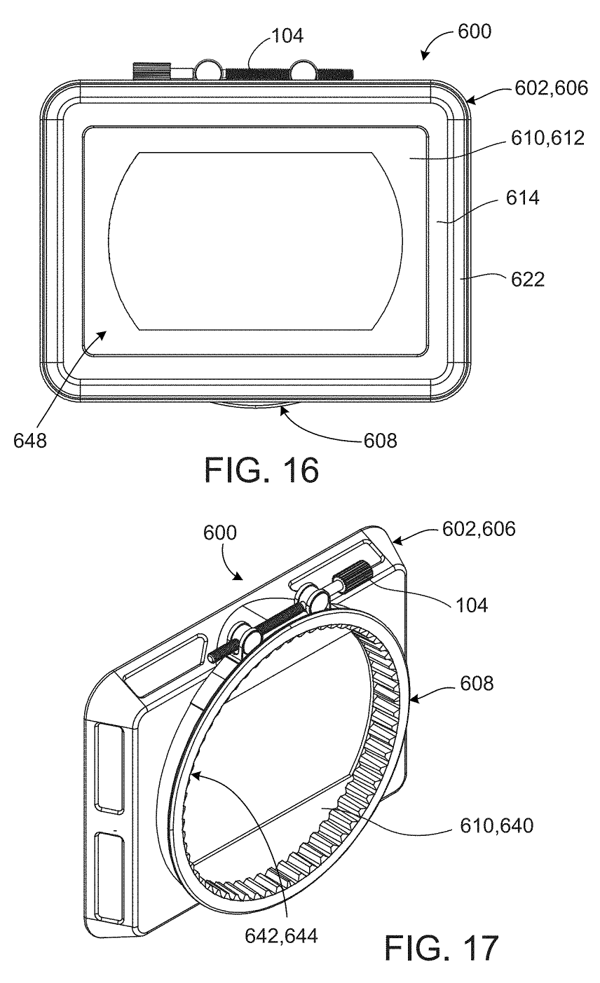

Referring to FIGS. 16 and 17, the support structure 602 of the filter holder 600 is sized to accommodate a filter (e.g., a rectangular filter) that has a length of 142.2 mm, a width of 100 mm, and a thickness of 4 mm. Accordingly, a sleeve 648 defined by a seat 606 of the support structure 602 typically has a nominal length of about 141.7 mm to about 142.7 mm (e.g., 142.2 mm), a nominal width of about 99.5 mm to about 100.5 mm (e.g., 100.0 mm), and a nominal thickness of about 3.8 mm to about 4.2 mm (e.g., 4.0 mm). The support structure 602 of the filter holder 600 is sized to accommodate camera lenses with lens bodies that have outer diameters ranging from 110 mm to 115 mm. Thus, multiple projections 644 lining a cylindrical wall 642 of a mount 608 of the support structure 602 typically define a nominal internal diameter of about 111.0 mm to about 113.0 mm (e.g., 112.0 mm). A hood 622 of the seat 606 typically provides a coverage distance (e.g., as measured axially from a rear side of a lip 614 of the seat 606 to an outer-most edge of the hood 622) of about 12.3 mm to about 13.3 mm (e.g., 12.8 mm). The support structure 602 typically has a total thickness (e.g., a depth) of about 29.3 mm to about 30.3 mm (e.g., 29.8 mm). A thickness of a wall 610 of the seat 606 between a flat surface 612 against which the filter is seated and a rear side 640 against which a lens body of a camera lens is abutted through the mount 608 is typically about 1.4 mm to about 1.6 mm (e.g., 1.5 mm).

While the support structures 102, 302, 402, 502, 602 of the filter holders 100, 300, 400, 500, 600 have been described as being made of one or more rubber materials, in some embodiments, a support structure of a filter holder that is substantially similar in structure and function to any of the filter holders 100, 300, 400, 500, 600 may include one or more rubber materials and one or more non-rubber materials.

While the filter holders 100, 300, 400, 500, 600 have been described for use with filters of width 100 mm and length 100 mm or 142.2 mm, in some embodiments, a filter holder that is substantially similar in structure, material formulation, and function to any of the filters 100, 300, 400, 500, 600 may be sized to accommodate a filter that has different dimensions (e.g., a filter that has a width of 100 mm and a length of 144 mm or a filter that has other dimensions).

While the filter holders 100, 300, 400, 500, 600 have been described for use with camera lenses with lens bodies that have outer diameters within a range of 80 mm to 85 mm, 90 mm to 95 mm, or 110 mm to 115 mm, in some embodiments, a filter holder that is substantially similar in structure, material formulation, and function to any of the filters 100, 300, 400, 500, 600 may be sized to accommodate camera lens bodies that have a different range of diameters.

While the filter holders 100, 300, 400, 500, 600 have been described as including the hose clamp 104, in some embodiments, a filter holder that is substantially similar in structure, material formulation, and function to any of the filters 100, 300, 400, 500, 600 may include a different type of adjustable clamp.

A number of embodiments have been described. Nevertheless, it will be understood that various modifications may be made without departing from the spirit and scope of the claims.

1. A method of securing a filter to a camera lens, comprising:
urging the filter into a flexible sleeve of a filter holder such that the flexible sleeve stretches to accommodate the filter and grasps the filter along a front side of the filter and along a rear side of the filter that is opposite the front side;
placing a flexible camera lens mount of the filter holder around the camera lens; and
securing the flexible camera lens mount of the filter holder to the camera lens such that the filter, held within the flexible sleeve, is positioned in front of the camera lens,
wherein the flexible sleeve and the flexible camera lens mount are both integrally defined by a same, unitary support component that comprises a stretchable material, such that the flexible sleeve is located in a permanently fixed orientation with respect to the flexible camera lens mount.

2. The method of claim 1, wherein the same, unitary support component is made of a rubber material.

3. The method of claim 1, further comprising shielding the filter with a hood that is integrally defined by the same, unitary support component and that surrounds the flexible sleeve, wherein the hood is located in a fixed orientation with respect to a central axis of the filter holder.

4. The method of claim 1, wherein securing the flexible camera lens mount of the filter holder to the camera lens comprises releasably attaching the flexible camera lens mount to the camera lens using an adjustable clamp that is separable from the flexible camera lens mount and that is sized to surround the flexible camera lens mount.

5. (canceled)

6. The method of claim 1, further comprising urging the flexible camera lens mount of the filter holder onto the camera lens such that the flexible camera lens mount stretches to accommodate the camera lens.

7. The method of claim 1, wherein securing the flexible camera lens mount of the filter holder to the camera lens comprises tightening an adjustable clamp of the filter holder around the flexible camera lens mount and the camera lens.

8. The method of claim 1, wherein securing the flexible camera lens mount of the filter holder to the camera lens comprises positioning the filter at a distance of about 1.4 mm to about 1.6 mm from a front end of the camera lens.

9. The method of claim 1, wherein the camera lens has an outer diameter within an inclusive range of 80 mm-85 mm, 90 mm-95 mm, or 110 mm-115 mm.

10. The method of claim 1, wherein the filter has a width of 100 mm and a length of 100 mm or 142.2 mm.

11. A filter holder for securing a filter to a camera lens, the filter holder comprising:
a flexible filter sleeve configured to stretch to accommodate the filter and to grasp the filter along a front side of the filter and along a rear side of the filter that is opposite the front side; and
a flexible camera lens mount configured to be placed around the camera lens and to be secured to the camera lens to position the filter in front of the camera lens with the filter held within the flexible filter sleeve,
wherein the flexible filter sleeve and the flexible camera lens mount are both integrally defined by a same, unitary support component that comprises a stretchable material, such that the flexible filter sleeve is located in a permanently fixed orientation with respect to the flexible camera lens mount.

12. The filter holder of claim 11, wherein the same, unitary support component is made of a rubber material.

13. The filter holder of claim 11, wherein the same, unitary support component further integrally defines a hood that surrounds the flexible filter sleeve, and wherein the hood is located in a fixed orientation with respect to a central axis of the filter holder.

14. The filter holder of claim 11, further comprising an adjustable clamp by which the flexible camera lens mount can be releasably secured to the camera lens, that is separable from the flexible camera lens mount, and that is sized to surround the flexible camera lens mount.

15. The filter holder of claim 11, wherein the flexible camera lens mount is formed as a ring that can be placed around the camera lens.

16. The filter holder of claim 11, wherein the flexible camera lens mount is formed as a ring that can be urged onto the camera lens such that the ring stretches to accommodate the camera lens.

17. The filter holder of claim 11, wherein the flexible filter sleeve comprises a wall including a first side that is configured to support the filter and a second side that is configured to contact a front end of the camera lens, the wall having a thickness of about 1.4 mm to about 1.6 mm.

18. The filter holder of claim 11, wherein the camera lens has an outer diameter within an inclusive range of 80 mm-85 mm, 90 mm-95 mm, or 110 mm-115 mm.

19. The filter holder of claim 11, wherein the filter has a width of 100 mm and a length of 100 mm or 142.2 mm.

20. A filter holder for securing a filter to a camera lens, comprising:
a flexible filter grasping means that is configured to stretch to accommodate the filter and to grasp the filter along a front side of the filter and along a rear side of the filter that is opposite the front side; and
a flexible camera lens mounting means that is configured to be placed around the camera lens and to be secured to the camera lens to position the filter in front of the camera lens when the filter is held within the flexible filter grasping means,
wherein the flexible filter grasping means and the flexible camera lens mounting means are both integrally defined by a same, unitary supportive component means that comprises a stretchable material, such that the flexible filter grasping means is located in a permanently fixed orientation with respect to the flexible camera lens mounting means.

21. The filter holder of claim 11, wherein the flexible filter sleeve and the flexible camera lens mount are permanently fixed along a central axis of the unitary support component.
